(19) United States
(12) Patent Application Publication
(10) Pub. No.: US 2015/0204518 A1
(43) Pub. Date: Jul. 23, 2015

(54) Light-Emitting Diode Lamp

(71) Applicants: Vladimir Vladimirovich Elkin, (US); Aleksei Mikhailovich LESCHEV, (US); Gennady Mikhailovich MIKHEEV, (US)

(72) Inventors: Aleksei Mikhailovich Leschev, Votkinsk (RU); Gennady Mikhailovich Mikheev, Izhevsk (RU); Aleksandr Sergeevich Saushin, Izhevsk (RU)

(73) Assignee: Vladimir Vladimirovich Elkin, Votkinsk (RU)

(21) Appl. No.: 14/421,317

(22) PCT Filed: Oct. 25, 2012
(86) PCT No.: PCT/RU2012/000865

§ 371 Date: Feb. 12, 2015

(30) Foreign Application Priority Data
Aug. 13, 2012 (RU) 2012134667

(51) Int. Cl. F21V 13/10; F21K 99/00

(52) U.S. Cl. CPC F21V 13/10; F21K 9/50; F21Y 2101/02

(57) ABSTRACT

The light-emitting diode lamp comprises a body, a diffusing cover and a plurality of partially reflective plates. The partially reflective plates are mounted simultaneously normally to an intersecting plane, which passes perpendicularly to a body board and plane, and at an inclination to the body at various angles in space between the body and the diffusing cover. The light-emitting diode lamp can be provided with an end reflective plate which is mounted at an inclination to the body between the body and the diffusing cover behind the final partially reflective plate in succession, and also with a front reflective plate which is mounted between the partially reflective plates and the body. The end reflective plate and the front reflective plate have a high coefficient of light reflection.

The invention relates to lighting technology, in particular to energy-saving illuminating devices, which are created on the basis of powerful light-emitting diodes with long service life. It can be used to construct non-dazzling illuminators for lighting of premises like living rooms, office rooms, stair landings as well as for street and road lighting.

A light-emitting diode (LED) lamp is known (MπK F21V8/00 (2006 Jan.), utility model RU 113333 U1), which comprises a body from heat-conducting material with a bar with LEDs and driver for power supply of the LEDs installed inside it, and a diffusing cover from transparent material, differing in that LED bar is mounted on a heat-conducting bracket having tight thermal contact with the body. This lamp has simple design. It allows solving a problem of heat removal from the LEDs. However such LED lamp will have a dazzling effect when powerful LEDs are used as a light source, since simple diffuser from transparent material is utilized in the lamp for radiation diffusing and powerful LEDs have high brightness.

A LED lamp is known (utility model RU 110816 U1), dazzling effect in which can be eliminated. It consists of one LED or group of LEDs. A transparent optical element that forms lamp's luminous flux is installed opposite the light source. This lamp utilizes the optical element made as protective glass with local and/or regular curvature and/or thickness and/or optical properties variations, to diffuse the radiation, i.e. to reduce brightness of every particular LED. In addition, the following solutions are provided to ensure more uniform illumination: making optical element glass as Fresnel lens; making micro prisms on optical element glass surface; making at least one group lens on optical element glass for all or part of LEDs; making lenses or lens groups on optical element glass surface located above all or part of LEDs. Such design of the LED lamp is not optimum in terms of production because of complex technology of production of mentioned above optical elements (Fresnel lenses, micro prisms, group lens, lenses and/or lens groups above each LED or part of LEDs).

Also LED lamp with reflectors is known ((51) MπK F21S 8/10 (2006 Jan.) RU(2 401 395 C1)). This invention is aimed to design the LED lamp with reduced dazzling effect. According to this invention, the lamp comprises a power supply, body with board, on which three rows of LEDs are installed, reflective plates with high reflectivity coefficient installed at the angle 60° to the board plane behind the first row, at the angle 45° to the board plane behind the second row and at the angle 90° to the board plane behind the third row. Such LED lamp has reduced dazzling effect when mounted at relatively big distance from the point to be illuminated, i.e. when it is used for lighting of open spaces, access motor roads, quarries, piers, etc. The drawback of this lamp is in impossibility to use it inside the rooms because of strong dazzling effect since use of reflective plates does not exert influence on LED brightness in some directions.

The invented lamp with reflectors (U.S. Pat. No. 4,929,866 A, F21S8/10, 29 May 1990) is the closest analog of claimed solution selected as a prototype. This invention is aimed to design the LED lamp with reduced dazzling effect intended for use in rear lights of motor vehicles. The lamp according to this invention comprises a body, a number of LEDs installed in the body, a solid light reflector made as complex reflective surface and comprising a multitude of high-efficient reflective surfaces laying in different planes; a window for radiation output fitted with a diffuser. The solution in this invention provides for such arrangement of the LEDs that light reflector would send incident light towards the window diffuser. The values of angles between planes of the reflector reflective surfaces and axis of LED angular distribution diagram fall in the range between 20 and 60 degrees. Such LED lamp is featured by reduced dazzling effect. However radiation of any LED has its own angular distribution pattern. For most of LEDs, main portion of radiation power is concentrated within some spatial angle oriented along the angular distribution diagram axis. This aspect leads to the fact that main portion of radiated power will reach small number of adjacent “basic” reflective surfaces on the reflectors of this device. Due to short distance between the light reflector and the window and despite of the fact that angles between planes of the reflector reflective surfaces and axis of LED angular distribution diagram can fall in the range between 20 and 60 degrees, the radiation reflected from these “basic” reflective surfaces will come to virtually same spot on the output window diffuser surface. This leads to non-uniform illumination of the overall diffuser and affects the lighting quality. Thus, dazzling effect is not eliminated completely. Moreover, this solution provides for location of virtual LED images appearing on reflectors' reflective surfaces at different distances from the output window diffuser. This circumstance additionally increases the distribution non-uniformity of light flux incoming onto the output window diffuser. All these aspects have negative effect on quality of the light flux emitted by the lamp constructed according to this solution. It should be noted in addition that making of the solid light reflector designed as complex reflective surface and including a multitude of high-efficient reflective surfaces laying in different planes, complicates the lamp design. In order to ensure more uniform illumination, this solution can provide for arrangement of the LEDs on the upper and lower parts of the lamp body. In this case, each row of upper LEDs requires its own solid reflector (first) and each row of lower LEDs requires another solid reflector (second), arranged in a certain manner relative to the first one. Such feature adds to complexity of the lamp design according to this solution.

The aim of the invention is to eliminate dazzling effect of the LED lamp, with simplification of its design at the same time. The accomplishment of the task is realized through the construction arrangement, in which the LED board is mounted perpendicularly to the plane of the body of the LED lamp comprising power supply, body, light diffusing cover, reflective plates and board with LEDs; and the reflective plates are made as several partially reflective plates separated by an air gap and located perpendicularly to the secant plane that is perpendicular to the board and body plane and, at the same time, obliquely to the body at different angles γ in the space between the body and diffusing cover in such a way that angles γ satisfy the condition 8°<γ<50°, and reflecting (the LED radiation) surfaces of the reflective plates are faced towards the diffusing cover.

The LED lamp can be provided with end reflective plate with high light reflection coefficient, which is mounted at an inclination to the body, between the body and the diffusing cover, behind the final partially reflective plate, when counting from the board.

The LED lamp can be provided with front reflective plate with high light reflection coefficient, which is mounted between the body and the partially reflective plates.

The partially reflective plates in the LED lamp can be in the form of optically transparent plates mounted at various angles γ to the body as follows:

γ₁>γ₂> . . . γₙ₋₁>γₙ, where γ₁, γ₂ . . . γₙ₋₁, γₙare angles between the body and 1^{st}, 2^{nd}, . . . , n−1, n optically transparent plate, respectively, when counting from the board.

The technical result consists in eliminating dazzle and simplifying the design of the LED lamp.

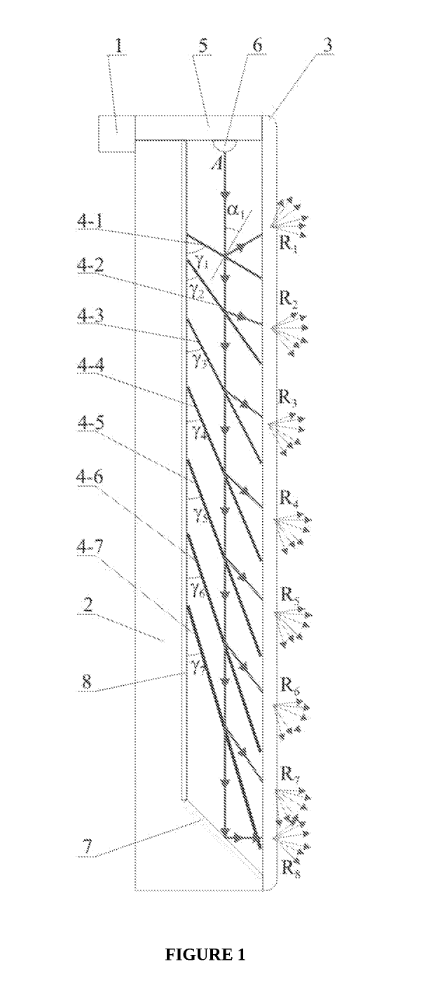

FIG. 1 represents the LED lamp with seven partially reflective plates in the form of optically transparent plates, according to this invention, and path of central ray A of one of LEDs, propagating along the LED directional pattern axis in secant plane σ₀, which is perpendicular to the board and body plane:
1—power supply;
2—body;
3—diffusing cover;
4-1, 4-2, . . . 4-7—optically transparent plates;
5—board;
6—LED;
7—end reflective plate with high light reflection coefficient;
8—front reflective plate with high light reflection coefficient;
γ₁, γ₂, . . . , γ₆, γ₇—angles between the body and 1^{st}, 2^{nd}, . . . , 7^{th} optically transparent plate, respectively, when counting from the board.

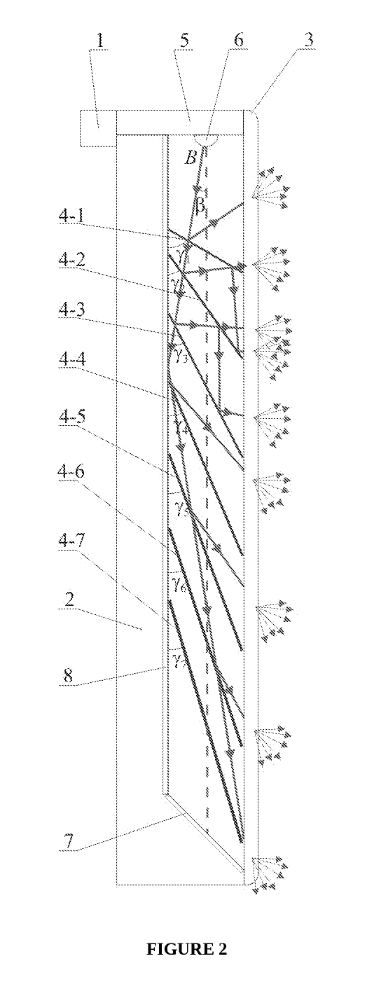

FIG. 2 represents the LED lamp with seven partially reflective plates in the form of optically transparent plates, according to this invention, and path of ray [symbol] laying in secant plane σ₀ and propagating at some angle 13 relative to central ray A of one of LEDs:
1—power supply;
2—body;
3—diffusing cover;
4-1, 4-2, ...4-7—optically transparent plates;
5—board;
6—LED;
7—end reflective plate with high light reflection coefficient;
8—front reflective plate with high light reflection coefficient;
γ₁, γ₂, . . . , γ₆, γ₇—angles between the body and 1^{st}, 2^{nd}, . . . , 7^{th} optically transparent plate, respectively, when counting from the board.

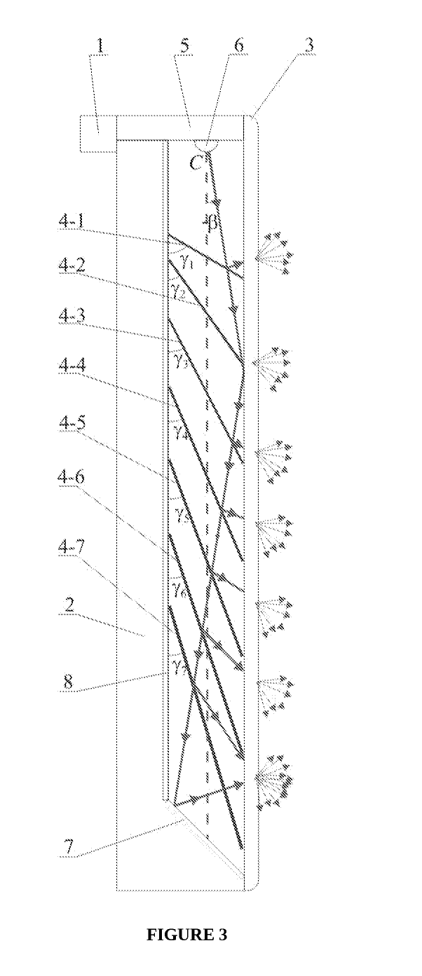

FIG. 3 represents the LED lamp with seven partially reflective plates in the form of optically transparent plates, according to this invention, and path of ray B laying in secant plane σ₀ and propagating at some angle −β relative to central ray A of one of LEDs:
1—power supply;
2—body;
3—diffusing cover;
4-1, 4-2, . . . 4-7—optically transparent plates;
5—board;
6—LED;
7—end reflective plate with high light reflection coefficient;
8—front reflective plate with high light reflection coefficient;
γ₁, γ₂, . . . , γ₆, γ₇—angles between the body and 1^{st}, 2^{nd}, . . . , 7^{th} optically transparent plate, respectively, when counting from the board.

FIG. 4 represents 3D view of the LED lamp, according to this invention, with seven partially reflective plates in the form of optically transparent plates and eight LEDs:
1—power supply;
2—body;
3—diffusing cover;
4-1, 4-2, . . . 4-7—optically transparent plates;
5—board;
6—LEDs;
7—end reflective plate with high light reflection coefficient;
8—front reflective plate with high light reflection coefficient

The LED lamp works as follows: When power supply is ON, LEDs located on the board light up and start to emit light. Radiation power distribution in space for each LED is determined by its directional pattern, i.e. the directional pattern determines angular width of LED beam. The angular width of the LED beam depends on its type. It can be, for example, as much as 120°.

Let us consider propagation of central ray A of one of LEDs 6 (the beam propagating along axis of its directional pattern) in secant plane σ₀, which is perpendicular to the board and body plane (FIG. 1). The central ray A of given LED incomes onto 1^{st} partially reflective plate at the angle α₁, where α₁=90°−γ₁. In this case, a portion of its full power P₀ is reflected and directed towards the diffusing cover 3. Reflection coefficient of 1^{st} partially reflective plate is r₁. If 1^{st} partially reflective plate is made as optically transparent plate, the coefficient r₁ is uniquely determined by angle of incidence α₁, and therefore, by angle γ₁. Thus, (1−r₁) P₀ of ray power reaches the 2^{nd} partially reflective plate. After passing 2^{nd} partially reflective plate, the value of radiation power incoming onto 3^{rd} partially reflective plate is equal to (1−r₂) (1−r₁) P₀, where r₂ is reflection coefficient of 2^{nd} partially reflective plate. When ray A passes partially reflective plate n, power of its radiation incoming onto end reflective plate is equal to (1−rₙ) (1−rₙ₋₁) . . . (1−r₂) (1−r₁) P₀, where rₙ₋₁, rₙ are reflection coefficients of partially reflective plates n−1 and n, respectively, when counting from the board. Then, the end reflective plate with high reflection coefficient reflects the rest portion of incident optical power towards the diffusing cover. The end reflective plate can be mounted at the angle 45° to the body. In this way, central rays that propagate along the LED directional pattern axis reach the diffusing cover in different points R₁, R₂, . . . Rₙ, Rₙ₊₁, as shown in FIG. 1, where point Rₙ₊₁ is created by reflection of ray A from the end reflective plate.

The reflection coefficients of the partially reflective plates and angles γ₁, γ₂, γ₃, . . . , γₙ₋₁, γₙ can be calculated in such a manner as to obtain approximately equal values of radiation power in the points R₁, R₂, . . . Rₙ, Rₙ₊₁. For that purpose, when number of partially reflective plates is, for example, seven, reflection coefficients r₁, r₂, r₃, r₄, r₅, r₆ and r₇ should have values 0.12; 0.136; 0.158; 0.188; 0.231; 0.3 and 0.429, respectively. In this case, all angles γ₁, γ₂, γ₃, . . . , γₙ₋₁, γₙ can have the same value of 45°. The partially reflective plates have such relative arrangement as to ensure approximately equal distances between adjacent points R₁ and R₂, R₂ and R₃, . . . , Rₙ₋₁ and Rₙ.

When 1^{st}, 2^{nd}, . . . , n−1, n partially reflective plates are made as optically transparent plates, their respective reflection coefficients r₁, r₂, . . . , rₙ₋₁, rₙ will be uniquely determined by refractive index of the plate material and incidence angles α₁, α₂, . . . , αₙ₋₁, αₙ, respectively, and therefore by angles γ₁, γ₂, γ₃, . . . , γₙ₋₁, γₙ . The calculations demonstrate that values of angles γ₁, γ₂, γ₃, . . . , γₙ₋₁, γₙ for usable cases can fall within the range 8°-50°.

Similarly, other LED rays laying in secant plane σ₀ and propagating, for example, at angle β to central ray, pass consecutively through the partially reflective plates (FIG. 2). But in this case the front reflective plate with high reflection coefficient has influence on propagation of these rays. Indeed, the ray [symbol] , emitted by the LED at some angle β to the ray A, as shown in FIG. 2, passes consecutively through three partially reflective plates, subjecting the reflection towards the diffusing cover on each of them. Further, the rest portion of ray [symbol] power reflects completely from the front reflective plate with high reflection coefficient and is directed to other partially reflective plates, subjecting the series of additional reflections towards the diffusing cover.

Similarly, light power of the ray B, emitted by the LED at some angle −β to the central ray A (FIG. 3), will be distributed over the surface of the diffusing cover as a result of reflection and refraction on the partially reflective plates as well as reflection from the end reflective plate.

In a similar way, LED rays laying in other planes σᵢ that are parallel to the secant plane σ₀ and passing through light-emitting surface of the LED of area S₀.

As a result of all these factors, LED radiation power is distributed over internal surface of the diffusing cover along the certain stripe. Section of this stripe is Sᵣ>(n+1) S₀. If m LEDs arranged in one row are located on the LED lamp board, see FIG. 4, then m luminous stripes will be formed on surface of the diffusing cover.

The diffusing cover serves for additional diffusion of incident radiation. It can have side walls that diffuse LED radiation propagating in the planes σᵢ^{⊥}, perpendicular to the secant plane σ₀. In addition, the diffusing cover with side walls allows isolation of the optical elements (LED, partially reflective plates, end and front reflective plates) from environment to avoid dust loading.

A dazzling effect of a light source is determined by its brightness. The higher is the brightness, the stronger is dazzling effect. Brightness is defined as flux emitted by unit of area of visible surface in given direction within unit spatial angle. Therefore, at given power of the light source its brightness is inversely proportional to the area of emitting surface.

The invented LED lamp, due to use of n partially reflective plates and end reflective plate with high reflection coefficient mounted at various distances from LED light-emitting surface, area of emitting surface Sᵣ, formed on internal surface of the diffusing cover, is increased in k (n+1) times, where k is some numerical coefficient (k>>1) depending on angular width of the LED beam and distance from the board to end reflective plate. Therefore, dazzling effect of this invented LED lamp is reduced in k (n+1) times compared with LED lamp, in which no provisions were made to enlarge area of emitting surface.

We should note that use of front reflective plate with high reflection coefficient allows reduction of light losses due to re-reflection of LED rays propagating towards the body in direction towards the diffusing cover.

Number of LEDs in this invented LED lamp can vary from one to several dozens and more. They can be arranged in one or several rows. The LEDs on the board can also be placed randomly. FIG. 4 shows 3D view of the LED lamp having 8 LEDs arranged in one row. Partially reflective plates can be made from optical material with reflective coating that ensures required reflection coefficient values. When partially reflective plates are made as optically transparent plates, they can be manufactured from any material, transparent for visible light, e.g. glass or polycarbonate.

### Example of Specific Design

The LED lamp made according to this invention has dimensions 30×75×150 mm. It has one row of MX3AWT-A1-0000-000CE3 LEDs (made by Cree), 8 pieces in total. The emitting surface of each LED is concentrated in a circle of diameter 4.2 mm, at beam angular width 120°. The partially reflective plates are made from transparent optical glass 0.5 mm thick, with refraction index equal to 1.5. Number of the plates is 7 pieces. They are arranged at the angles γ₁=36°, γ₂=29°, γ₃=24°, γ₄=19°, γ₅=16°, γ₆=13° and γ₇=10° relative to the body. The end and front reflective plates are made from aluminum foil. The diffusing cover is made from polycarbonate with matt surface. The LED lamp made according to this invention ensures uniform illumination at rated LED supply current 350 mA. There is no dazzling effect in this case.

1. A light-emitting diode lamp comprising a power supply, body, light diffusing cover, reflective plates and board with LEDs, differing in that the board is mounted perpendicularly to the plane of the body, and the reflective plates are made as several partially reflective plates separated by an air gap and located perpendicularly to the secant plane that is perpendicular to the board and body plane and, at the same time, obliquely to the body at different angles γ in the space between the body and diffusing cover in such a way that angles γ satisfy the condition 8°<γ<50°, and reflecting surfaces of the reflective plates are faced towards the diffusing cover.

2. A light-emitting diode lamp of claim 1 further comprising a end reflective plate with high light reflection coefficient, which is mounted at an inclination to the body, between the body and the diffusing cover, behind the final partially reflective plate, when counting from the board.

3. A light-emitting diode lamp of claim 1 further comprising a front reflective plate with high light reflection coefficient, which is mounted between the body and the partially reflective plates.

4. A light-emitting diode lamp of claim 1 further wherein the partially reflective plates are in the form of optically transparent plates mounted at various angles γ to the body as follows:
γ₁>γ₂> . . . γₙ₋₁>γₙ,
where γ₁, γ₂ . . . γₙ₋₁, γₙare angles between the body and 1^{st}, 2^{nd}, . . . , n−1, n optically transparent plate, respectively, when counting from the board.
